(19) United States
(12) Patent Application Publication
(10) Pub. No.: US 2015/0109581 A1
(43) Pub. Date: Apr. 23, 2015

(54) SIMULATED-HOLOGRAPHIC IMAGE DISPLAY SYSTEM

(71) Applicant: REINALDO WAISMAN, RIO DE JANEIRO (BR)

(72) Inventor: REINALDO WAISMAN, RIO DE JANEIRO (BR)

(21) Appl. No.: 14/550,347

(22) Filed: Nov. 21, 2014

Related U.S. Application Data
(63) Continuation-in-part of application No. 14/117,184.

(51) Int. Cl. G02B 27/22; G03B 31/00; G02B 27/42; G03B 21/14; G03B 21/28; G03B 21/62; G03B 21/10

(52) U.S. Cl. CPC G02B 27/2221; G03B 21/62; G03B 31/00; G03B 21/10; G03B 21/142; G03B 21/28; G02B 27/2292; G02B 27/4205
USPC 353/10

(57) ABSTRACT

An image display system can include a shaped screen, a mirror image of an item stored in an electronic format, a presentation component, and an attachment mechanism. The shaped screen can have one surface with a diffraction grating. The shaped screen can correspond to the shape of an item to be displayed and can be made of a substantially transparent material. The presentation component can be configured to present a simulated-holographic image of the item upon the shaped screen. The mirror image can be visually projected upon the shaped screen, where the light of the projection is dispersed by the diffraction grating to substantially simulate a three-dimensional holographic image from the two-dimensional mirror image.

### CROSS-REFERENCE TO RELATED APPLICATIONS

This application is a continuation-in-part of pending application Ser. No. 14/117,184, filed Nov. 12, 2013, entitled “EQUIPMENT FOR PROJECTION OF IMAGES, IN POINTS OF SALE, SIMULATING A HOLOGRAPHY”. Application Ser. No. 14/117,184 is a national stage entry of PCT/BR13/00143, filed Jul. 31, 2013. This application claims priority to both the U.S. Application and the PCT Application.

### BACKGROUND

The present invention relates to the field of image projection and, more particularly, to a simulated-holographic image display system.

It is common for technological advances, particularly in image presentation, to become adopted for retail or public venue use. Many supermarkets now utilize flat-screen display devices to present commercials or helpful tips to consumers as they shop. However, technology tends to advance faster than it is cost-effective for use in such settings. Yet, the use of newer technology is known to grab consumers' attention.

Holographic imagery is one such technology that is attention-grabbing, but still too costly and cumbersome for widespread use. Thus, there is a definite need for a means to provide simple holographic imagery in a cost-effective manner to capitalize upon its uniqueness to promote products or present information.

### BRIEF SUMMARY

One aspect of the present invention can include an image display system that includes a shaped screen, a mirror image of an item stored in an electronic format, a presentation component, and an attachment mechanism. The shaped screen can have one surface with a diffraction grating. The shape of the shaped screen can correspond to the shape of an item to be displayed and can be made of a substantially transparent material. The presentation component can be configured to present a simulated-holographic image of the item upon the shaped screen. The mirror image can be visually projected upon the shaped screen, where the light of the projection is dispersed by the diffraction grating to substantially simulate a three-dimensional holographic image from the two-dimensional mirror image.

Another aspect of the present invention can include a product display that includes a piece of furniture designed to display products to a consumer and a simulated-holographic image display system. The simulated-holographic image display system can be installed upon the piece of furniture and can present a simulated-holographic image of the product to the consumer. The simulated-holographic image can appear to float in mid-air and substantially proximate to the products displayed upon the piece of furniture. Components of the simulated-holographic image display system can be substantially hidden from the consumer.

Yet another aspect of the present invention can include an image display method that begins with the installation of a simulated-holographic image display system within a display location. The simulated-holographic image display system can be configured for presentation of a simulated-holographic image. Configuration can provide the simulated-holographic image display system with configuration data that includes a two-dimensional mirror image of an item and settings that govern operation of the simulated-holographic image display system. In response to activation of the presentation of the simulated-holographic image, the mirror image can be continuously projected upon a shaped screen that substantially resembles the item. The shaped screen can be made of a substantially transparent material and can include a diffraction grating that disperses the projected mirror image to substantially simulate a three-dimensional holographic image of the item. The timing for projecting the mirror image can be defined in the settings.

### BRIEF DESCRIPTION OF THE SEVERAL VIEWS OF THE DRAWINGS

FIG. 1 is a schematic diagram illustrating a system for utilizing a simulated-holographic image display system in accordance with embodiments of the inventive arrangements disclosed herein.

FIG. 2 is a general embodiment of the image display system in accordance with an embodiment of the inventive arrangements disclosed herein.

FIG. 2A is a specific embodiment of the image display system in accordance with an embodiment of the inventive arrangements disclosed herein.

FIG. 3 is a flowchart of a method describing the general use of the image display system in accordance with an embodiment of the inventive arrangements disclosed herein.

FIG. 4 is a collection of illustrations illustrating uses for the image display system in accordance with an embodiment of the inventive arrangements disclosed herein.

### DETAILED DESCRIPTION

The present invention discloses a solution for generating a simulated-holographic image. A simulated-holographic image display system can project a two-dimensional mirror image of an item upon a specialized screen. The specialized screen can be made of a substantially transparent material and can be shaped like the item. One surface of the screen can have a diffraction grating. The diffraction grating can disperse the projected image into two images that are separated by a small distance, simulating a three-dimensional image of the item.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wireline, optical fiber cable, RF, etc., or any suitable combination of the foregoing. Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

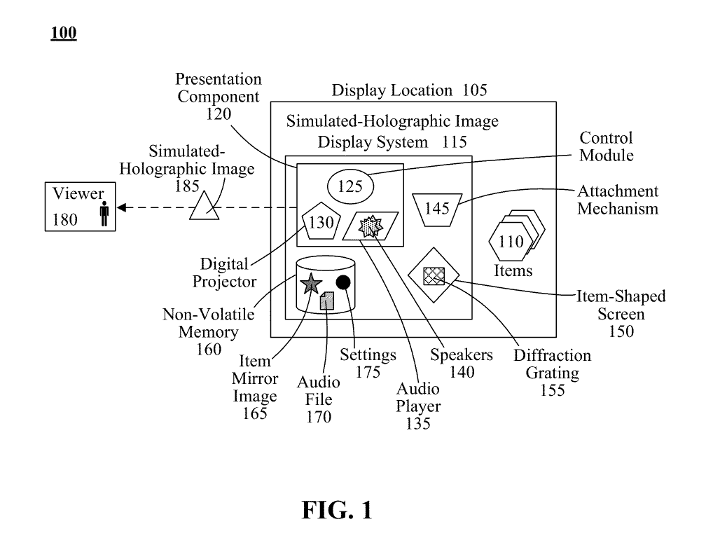

FIG. 1 is a schematic diagram illustrating a system 100 for utilizing a simulated-holographic image display system 115 in accordance with embodiments of the inventive arrangements disclosed herein. In system 100, the simulated-holographic image display system 115, herein referred to as the image display system 115, can present a viewer 180 with a simulated-holographic image 185 within a display location 105.

The display location 105 can represent a variety of physical locations capable of supporting operation of the image display system 115 as well as displaying one or more items 110. An item 110 can be a physical object positioned within the display location 105. For example, the display location 105 can be a stand or shelving unit within a grocery store that displays boxes 110 of cookies for sale. As another example, the display location 105 can represent a clothing store window having clothing, decorations, and mannequins 110.

The image display system 115 can be hardware and/or software required to produce the simulated-holographic image 185. The image display system 115 can include a presentation component 120, an attachment mechanism 145, an item-shaped screen 150, non-volatile memory 160 for data storage, and the like.

The presentation component 120 can represent the component that presents the simulated-holographic image 185. The presentation component 120 can include a control module 125, a digital projector 130, an audio player 135, and the like.

The digital projector 130 can utilize optical technology to project the item mirror image 165 onto the item-shaped screen 150. The digital projector 130 can utilize 3-chip liquid crystal display (3LCD), digital light processing (DLP), liquid crystal on silicon (LCOS) technologies, and the like. Size and power requirements can influence selection of a digital projector 130 for a specific embodiment of the present invention.

The audio player 135 can be the component that handles playback of one or audio files 170. An audio file 170 can be a recording of audio data in a format playable by the audio player 135. The audio player 135 can include one or more speakers 140 to produce the audio sounds to be heard by the viewer 180.

In other contemplated embodiments of the present invention, the audio player 135 and audio file 170 can be omitted for image-only implementations.

The control module 125 can be the hardware and/or software elements that control operation of the presentation component 120. For example, the control module 125 can utilize a microprocessor to execute the instructions of a software program. The control module 125 can synchronize playback of the audio file 170 by the audio player 135 with the projection of the simulated-holographic image 185 by the digital projector 130 to produce an audio/visual presentation for the viewer 180.

The control module 125 can utilize values contained in the settings 175 to affect operation of the presentation component 120. The settings 175 can define various configurable operating parameters for the presentation component 120. For example, timing values for audio and/or image presentation can be defined in the settings 175 (i.e., audio playback can have multiple pause points during the presentation of the simulated-holographic image 185.

In another contemplated embodiment of the present invention, the presentation component 120 can include network communication components (e.g., a BLUETOOTH transceiver, a wireless transceiver, etc.) for exchanging data over a network. For example, new item mirror images 165 and audio files 170 or hardware/software updates can be downloaded to the presentation component 120 from an authorized data server (not shown). In such an embodiment, remote operation of the presentation component 120 can be enabled.

The item-shaped screen 150 can be the surface upon which the simulated-holographic image 185 is projected by the digital projector 130. The item-shaped screen 150 can be made from a substantially transparent material, such as acrylic or glass, to promote the illusion that the simulated-holographic image 185 is floating in mid-air. The item-shaped screen 150 can produced in a shape to resemble the items 100 in the display location 105; using an item-shaped screen 150 can assist in producing a simulated-holographic image 185 that more closely resembles the items 110.

One surface of the item-shaped screen 150 can have a diffraction grating 155. The diffraction grating 155 can disperse the light that is projected onto the item-shaped screen 150 by the presentation component 120. The diffraction grating 155 can, therefore, split the two-dimensional projected item mirror image 165 into two two-dimensional images 165 that are viewed at a slight separation, simulating a three-dimensional image 185. The actual specifications (e.g., thickness, type of diffraction grating, concavity, etc.) of the item-shaped screen 150 can be dependent upon the specific implementation and/or item 110 being represented.

The attachment mechanism 145 can be the element that connects the presentation component 120 and the item-shaped screen 150 into a single unit, securing the alignment between the digital projector 130 and the item-shaped screen 150. The attachment mechanism 145 can be made from a strong, substantially transparent material (e.g., glass, plastic, composites, etc.), so as to not draw attention to the image display system 115, promoting the floating image illusion. The attachment mechanism 145 can be designed to allow interchangeability between multiple item-shaped screens 150 and/or presentation components 120.

In another contemplated embodiment, the attachment mechanism 145 can include one or more adjustable elements (e.g., hinges, locking joints, etc.) to allow the image display system 115 to be repositioned within the display location 105.

In yet another embodiment, the image display system 115 can include sensor elements (not shown) that provide environmental inputs for the control module 125 to coordinate presentation of the simulated-holographic image 185. For example, a motion sensor can be used to detect when the viewer 180 approaches the image display system 115 and trigger the presentation component 120 to display the simulated-holographic image 185 and/or begin playback of the audio file 170.

In still another embodiment, the image display system 115 can include a user interface to allow configuration of the settings 175.

As used herein, presented non-volatile memory 150 can be a physical persistent storage space configured to store digital information. Non-volatile memory 160 can be physically implemented within any type of hardware including, but not limited to, a magnetic disk, an optical disk, a semiconductor memory, a digitally encoded plastic memory, a holographic memory, or any other recording medium. Additionally, information can be stored within non-volatile memory 160 in a variety of manners and can utilize one or more encryption mechanisms to protect stored information from unauthorized access.

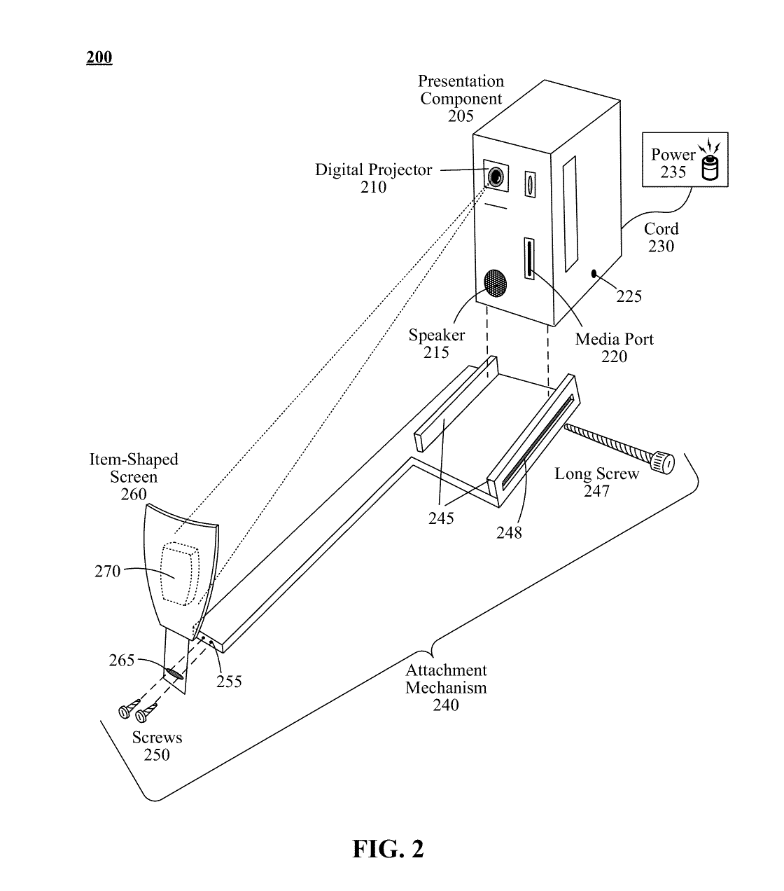

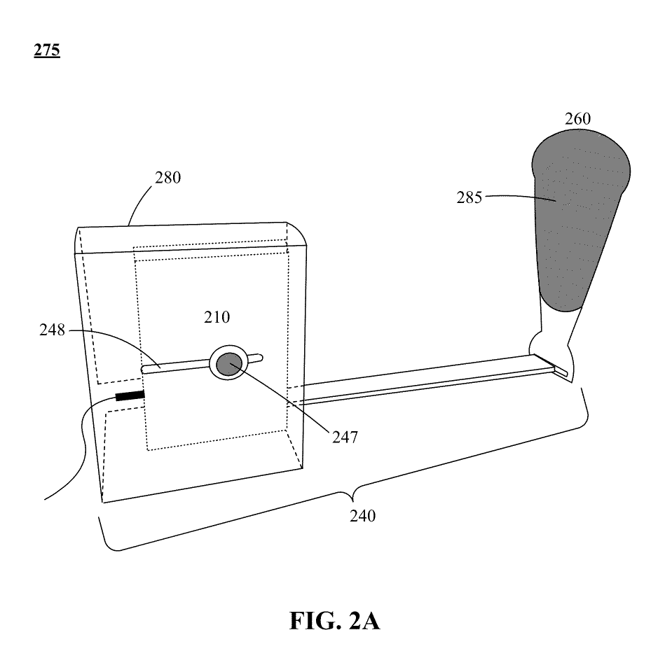

FIG. 2 is a general embodiment of the image display system 200 in accordance with embodiments of the inventive arrangements disclosed herein. Image display system 200 can be utilized within the context of system 100.

In this example embodiment, the attachment mechanism 240 can be a planar component having areas at its ends where the presentation component 205 and the item-shaped screen 260 can be attached. As shown in this example, the item-shaped screen 260 can be attached to the attachment mechanism 240 by two screws 250 that pass through an aperture 265 and into corresponding holes 255. Aperture 265 can be of a size so as to allow minor adjustments to the position of the item-shaped screen 260.

The presentation component 205 can be seated on the end of the attachment mechanism 240 opposite the item-shaped screen 260. In this example, the presentation component 205 can be seated between two guiderails 245. One guiderail 245 can include a cut-out 248 that a long screw 247 can pass through and couple with a corresponding hole 225 on the presentation component 205. The cut-out 248 and long screw 247 can allow the position of the presentation component 205 to be adjusted upon the attachment mechanism 240 during installation.

In this general embodiment, the presentation component 205 can include a digital projector 210, speaker 215, media port 220, and a cord 230 for connecting to power 235. Power 235 can be commercially provided by the location where the image display system 200 is installed (i.e., public power grid). Alternately, power 235 can be a battery system component installed with the image display system 200 and may not require cord 230.

The digital projector 210 can visually project light comprising an image onto the item-shaped screen 260. The diffraction grating of the item-shaped screen 260 can disperse the light to create the simulated-holographic image 270. Speaker 215 can be used to present audio content in concert with the presented simulated-holographic image 270.

The media port 220 can accept a portable storage media device like a secure digital (SD) memory card that can contain the mirror images and/or audio files required for the presentation of the simulated-holographic image 270.

Embodiment 275 of FIG. 2A can represent a specific implementation of the image display system 200. In this embodiment 275, the attachment mechanism 240 can include a protective housing 280 for the digital projector 210 (e.g., a commercial pico-projector). The housing 280, attachment mechanism 240, and item-shaped screen 260 can be made of a substantially transparent material.

The housing 280 can include the adjustment cut-out 248 through which the long screw 247 can secure placement of the digital projector 210. To avoid damaging the digital projector 210, the long screw 247 can be used to provide pressure like a clamp or vice.

The item-shaped screen 260 can have applied to it a rear projection film 285, such as a shadow-gray STICKYSCREEN film, that provides the light dispersion functionality of the diffraction grating. It should be noted that other types of rear projection films 285 can be utilized in other implementations and that selection of the rear projection film 285 can be dependent upon the specific requirements of the image display system 200.

Further, use of a rear projection film 285 can allow for lower costs of the overall image display system 200. That is, the rear projection film 285 can be less expensive than fabricating the item-shaped screen 260 with an embedded diffraction grating. Additionally, the rear projection film 285 can be removed from the item-shaped screen 260 to allow for easy replacement if damaged or interchangeability if another rear projection film 285 is required.

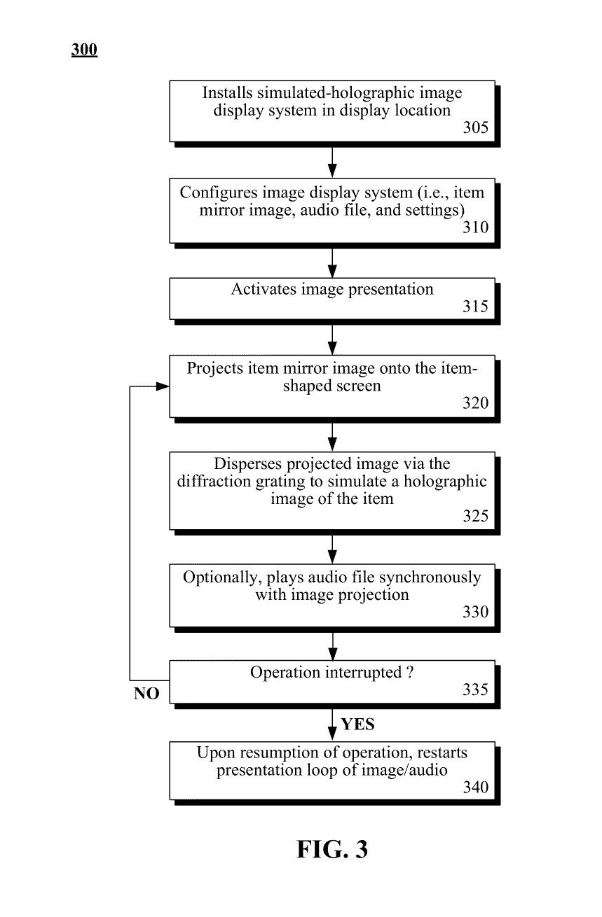

FIG. 3 is a flowchart of a method 300 describing the general use of the image display system in accordance with embodiments of the inventive arrangements disclosed herein. Method 300 can be performed within the context of system 100 and/or using the embodiment of FIG. 2.

Method 300 can begin in step 305 where the image display system can be installed within the display location. The image display system can be configured in step 310. Configuration of the image display system can include the uploading of the files required for the presentation of the simulated-holographic image as well as entry of setting values.

In step 315, the image presentation can be activated. The mirror image of the item can be projected onto the item-shaped screen in step 320. In step 325, the projected image can be dispersed by the diffraction grating of the item-shaped screen to simulate a holographic image of the item.

Optionally, an accompanying audio file can be played synchronously with the presentation of the simulated-holographic image in step 330. It should be noted that step 330 can occur in parallel with steps 320 and 325.

In step 335, it can be determined if operation of the image display system has been interrupted, such as a power outage, termination command, or component failure. When operation is not interrupted, flow of method 300 can return to step 320 where the item mirror image continues to be projected until operation is terminated.

When operation of the image display system is interrupted, upon resumption of operation, the image display system can restart the presentation loop of the image and/or audio in step 340. That is, the image display system can automatically restart its presentation without user intervention should operation be temporarily interrupted. Thus, the image display system can self-recover from minor power disruptions; component failures can still require manual rectification.

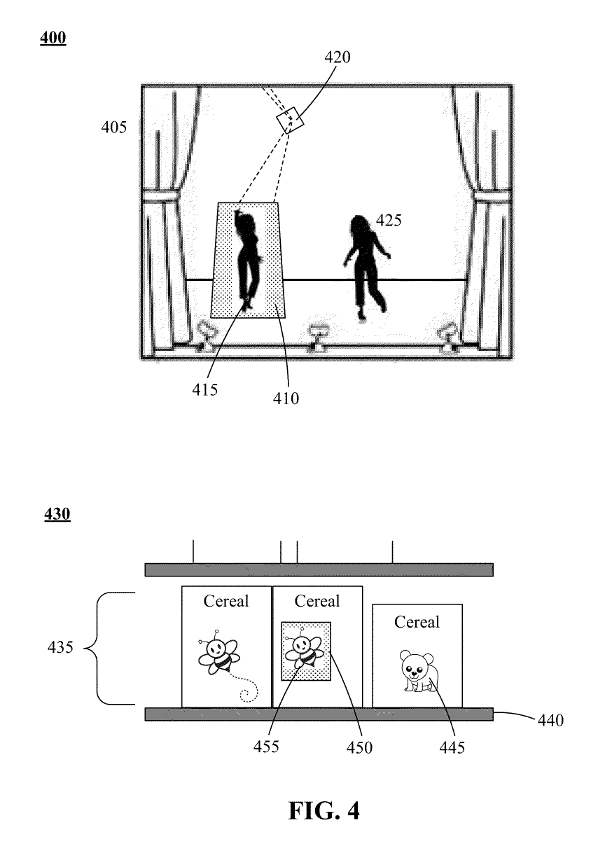

FIG. 4 is a collection of illustrations 400 and 430 illustrating uses for the image display system in accordance with an embodiment of the inventive arrangements disclosed herein. Illustrations 400 and 430 can utilize the concepts taught in system 100, embodiments 200 and 275, and/or method 300.

Illustration 400 can show the image display system being used in an entertainment performance. In this illustration 400, the item-shaped screen 410 can be installed upon a stage 405. The item-shaped screen 410 can be shaped similar to the performer 425 who is to be presented as a simulated-holographic image 415.

In such an environment, multiple item-shaped screens 410 can be used, some of which can utilize additional mechanical devices for movement. Additionally, one or more mirrors 420 can be used to reflect the light from the digital projector onto the item-shaped screen 410.

The concept of using holograms in performances is known. However, current techniques for rendering the holograms can be extremely expensive, which is a cost that a performance typically cannot recoup. The approach taught by the present invention can significantly reduce this cost and overhead by providing a simulated-holographic image, which requires less complicated components.

Illustration 430 can depict use of the image display system in a typical product display of a grocery store. In illustration 430, products 435, boxes of cereal, can be lined on a shelf 440. As is common with many products 435, each product 435 or brand can have an associated personality or character 445.

The item-shaped screen 450 of the image display system can be incorporated into a facsimile of the product 435 to provide a simulated-holographic image 455 of the character 445. In use, it can appear that the character 445 on the cereal box 435 animates, catching the attention of the shopper as they walk down the aisle. Unlike current approaches that use video screens, the substantially transparent nature of the image display system can provide a more realistic presentation than a two-dimensional video.

The flowchart and block diagrams in the Figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

What is claimed is:

1. An image display system comprising:
a shaped screen having one surface with a diffraction grating, wherein a shape of the shaped screen corresponds to the shape of an item to be displayed, wherein the shaped screen is made of a substantially transparent material;
a mirror image of the item stored in an electronic format; and
a presentation component configured to present a simulated-holographic image of the item upon the shaped screen, wherein the mirror image is visually projected upon the shaped screen, wherein light comprising the projection is dispersed by the diffraction grating of the shaped screen to substantially simulate a three-dimensional holographic image of the item from the two-dimensional mirror image.

2. The image display system of claim 1, wherein the presentation component further comprises:
an digital projector configured to utilize optical technology to visually project the mirror image;
a plurality of settings that define values for operational parameters of the presentation component; and
a control module configured to execute a sequence of machine-readable instructions that govern operation of the presentation component in accordance with the plurality of settings.

3. The image display system of claim 2, further comprising:
an audio playback component configured to play contents of an audio file of an appropriate format, wherein the control module synchronizes playback of the audio file with the mirror image projection.

4. The image display system of claim 3, wherein the audio playback component further comprises:
at least one speaker configured to produce audio sounds; and
an audio player software application configured to read the contents of the audio file and convey the contents to the at least one speaker for audio playback.

5. The image display system of claim 2, further comprising:
a non-volatile memory component for storing the mirror image, the sequence of machine-readable instructions, and the plurality of settings.

6. The image display system of claim 1, wherein the mirror image is a multi-media file that includes an audio component, wherein said presentation component includes components for audio playback.

7. The image display system of claim 1, further comprising:
an attachment mechanism that secures an alignment between the presentation component and the shaped screen, wherein the attachment mechanism is comprised of a planar component having attachment points for the shaped screen and presentation component at opposite ends, wherein said planar component is made from a substantially transparent material.

8. The image display system of claim 7, wherein the attachment points of the attachment mechanism include a means for making substantially minor adjustments to a position of at least one of the shaped screen and the presentation component.

9. The image display system of claim 1, further comprises:
at least one mirror for reflecting the light projected from the presentation component onto the shaped screen.

10. The image display system of claim 1, wherein the presentation component is substantially compact in size, so as to be substantially hidden within the display area.

11. The image display system of claim 1, wherein the configuration data includes a plurality of mirror images of the item, wherein projection of said plurality of mirror images by the presentation component produces animation of the simulated-holographic image.

12. A product display comprising:
a piece of furniture designed to display a plurality of products to a consumer; and
a simulated-holographic image display system installed upon said piece of furniture that presents a simulated-holographic image of a product to the consumer, wherein said simulated-holographic image appears to float in mid-air and substantially proximate to the plurality of products displayed upon the piece of furniture, wherein components of the simulated-holographic image display system are substantially hidden from the consumer.

13. The product display of claim 11, wherein the piece of furniture comprises one of a shelving unit, an end cap, a display fixture, a viewing case, a rack, and a bin.

14. The product display of claim 1, wherein the simulated-holographic image display system further comprises:
a shaped screen having one surface with a diffraction grating, wherein a shape of the shaped screen corresponds to the shape of the product displayed upon the piece of furniture, wherein the shaped screen is made of a substantially transparent material;
at least one mirror image of the product stored in an electronic format;
a presentation component configured to present a simulated-holographic image of the product upon the shaped screen, wherein the mirror image is visually projected upon the shaped screen, wherein light comprising the projection is dispersed by the diffraction grating of the shaped screen to substantially simulate a three-dimensional holographic image of the product from the two-dimensional mirror image; and
an attachment mechanism that incorporates the presentation component and the shaped screen into a single unit, secures an alignment between the presentation component and the shaped screen, and allows the unit to be installed upon the piece of furniture.

15. The product display of claim 14, wherein the presentation component further comprises:
an digital projector configured to utilize optical technology to visually project the at least one mirror image;
a plurality of settings that define values for operational parameters of the presentation component; and
a control module configured to execute a sequence of machine-readable instructions that govern operation of the presentation component in accordance with the plurality of settings.

16. The product display of claim 15 further comprising:
an audio playback component configured to play contents of an audio file of an appropriate format, wherein the control module synchronizes playback of the audio file with projection of the at least one mirror image.

17. An image display method comprising:
installing a simulated-holographic image display system within a display location;
configuring the simulated-holographic image display system for presentation of a simulated-holographic image, wherein said configuration provides the simulated-holographic image display system with configuration data comprising at least one two-dimensional mirror image of an item and a plurality of settings that govern operation of the simulated-holographic image display system;
in response to activation of the presentation of the simulated-holographic image, continuously projecting the at least one mirror image sequentially upon a shaped screen that substantially resembles the item, wherein said shaped screen is made of a substantially transparent material and includes a diffraction grating that disperses the projected at least one mirror image to substantially simulate a three-dimensional holographic image of the item, wherein a timing for projecting each mirror image is defined in the plurality of settings.

18. The method of claim 16, wherein configuration data includes an audio file for playback during the presentation of the simulated-holographic image.

19. The method of claim 16, wherein configuring the simulated-holographic image display system further comprises:
inserting a portable storage media device having the configuration data stored therein into an appropriate media port of the simulated-holographic image display system; and
automatically activating the presentation of the simulated-holographic image using contents of the portable storage media device.

20. The method of claim 16, further comprising:
when an operational interruption occurs, upon resumption of an operational state, automatically restarting the presentation of the simulated-holographic image using previously-entered configuration data.
